(19) United States
(12) Patent Application Publication
(10) Pub. No.: US 2014/0190414 A1
(43) Pub. Date: Jul. 10, 2014

(54) AUTONOMOUS DEVICE FOR EXECUTING ONE OR MORE OPERATIONS ON OR NEAR THE TEATS OF A DAIRY ANIMAL FOR THE PURPOSE OF MILKING THE DAIRY ANIMAL AND METHOD OF MILKING A DAIRY ANIMAL

(71) Applicant: LELY PATENT N.V., MAASSLUIS (NL)

(72) Inventor: Karel VAN DEN BERG, BLESKENSGRAAF (NL)

(73) Assignee: LELY PATENT N.V., MAASSLUIS (NL)

(21) Appl. No.: 14/205,394

(22) Filed: Mar. 12, 2014

Related U.S. Application Data
(63) Continuation of application No. PCT/NL2012/050604, filed on Sep. 3, 2012.

(30) Foreign Application Priority Data
Sep. 12, 2011 (NL) 2007395

(51) Int. Cl. A01J 5/003; A01J 5/017; A01J 7/04

(52) U.S. Cl. CPC A01J 5/003; A01J 7/04; A01J 5/0175
USPC 119/14.04

(57) ABSTRACT

An autonomous device for executing one or more operations on or near the teats of a dairy animal for the purpose of milking the dairy animal, including a self-propelled wheeled undercarriage which can travel freely across a floor surface in at least two independent directions, and a robot arm which is fitted to the undercarriage and configured to execute the one or more operations on or near the teats of the dairy animal, the device configured to execute the one or more operations in a milking device with a milking floor on which the dairy animals are situated during milking, and the device being supported on a stationary pit floor during the execution of the one or more operations, which pit floor is at a lower level than the milking floor.

### CROSS REFERENCE TO RELATED APPLICATIONS

This application is a continuation of PCT application number PCT/NL2012/050604 filed on 3 Sep. 2012, which claims priority from NL application number 2007395 filed on 12 Sep. 2011. Both applications are hereby incorporated by reference in their entireties.

### BACKGROUND OF THE INVENTION

1. Field of the Invention

The invention relates to an autonomous connecting device for executing one or more operations on or near the teats of a dairy animal for the purpose of milking the dairy animal, and to a method of milking a dairy animal.

2. Description of the Related Art

Milking devices with milking carousels are used to efficiently milk relatively large numbers of dairy animals. Such a milking device has a rotatable milking carousel comprising several milking stations which are distributed along the periphery of the milking carousel. Each milking station is provided with a set of milking cups which can be attached to the teats of a dairy animal which is situated in or on the milking station.

During use, the milking carousel is slowly rotated. Dairy animals are guided or allowed access to a milking station of the milking carousel in order to rotate along with the milking carousel, usually for a large part of a rotation.

During the stay on the carousel, the dairy animals are milked and, if necessary, fed. During the rotation of the dairy animal, various stages of the milking process are carried out in various sectors. In a first stage, the dairy animal is, for example, prepared for milking. This may comprise, for example, cleaning and/or massaging of the teats of the dairy animal. Thereafter, the actual milking of the dairy animal can commence. To this end, the one or more milking cups are attached to the teats of the dairy animal. After milking of the dairy animal, the milking cups can be detached from the teats again and be prepared for a subsequent milking operation. The milk obtained is discharged to a milk tank via a milk pipe system.

After the milking of the dairy animal has ended, the dairy animal may leave the milking carousel, after an optional after-treatment, so that the milking station becomes available for a new dairy animal to be milked.

In existing milking devices with milking carousels, the milking cups are often attached manually. An individual stands on the stationary pit floor which the milking stations with milking cups pass due to the rotation of the milking carousel. While the milking station passes by, the individual can attach the milking cups to the teats of the dairy animal in order to enable milking.

It is in itself desired to provide milking devices by means of which milking of dairy animals can be executed automatically. However, it is not always an attractive proposition to replace entire milking devices since the existing milking devices may represent a considerable investment. This is particularly true for milking devices with a milking carousel which are usually configured for milking a large number of dairy animals, for example in a milking carousel comprising more than 50 milking stations.

### BRIEF SUMMARY OF THE INVENTION

The invention provides an autonomous device for executing one or more operations on or near the teats of a dairy animal for the purpose of milking the dairy animal, the device comprising:

a self-propelled wheeled undercarriage which can travel across a floor surface, and
a robot arm fitted to the undercarriage and configured to execute the one or more operations on or near the teats of the dairy animal,
wherein the device is configured to execute the one or more operations in a milking device with a rotatable milking floor on which the dairy animals are situated during milking, and wherein the device is supported on a stationary pit floor during the execution of the one or more operations, which pit floor is situated lower than the milking floor such that an average milker can carry out the operations required for milking on the dairy animal while standing on the pit floor.

By providing an autonomous device which can move itself across the pit floor, no significant modifications of the existing milking device are necessary in order to automate the execution of the operations, in particular the attachment of the milking cups of the existing milking device. The automation of the existing milking device can thus be performed quickly and the execution of the operations can also readily be carried out in a conventional manner should the autonomous device be temporarily unavailable. All this is not possible or not readily possible with existing completely automated carousels in such a manner that the health and safety regulations are satisfied. The vehicle may, for example, be self-propelled on rails which are recessed into the pit floor, so that a milker is not hampered in his movements on the pit floor if the autonomous device has to be replaced.

In an embodiment, the self-propelled wheeled undercarriage can travel in at least two independent directions and freely.

The phrase “can travel in at least two independent directions and freely” is intended to mean that the vehicle can be moved in at least two directions, in which case a direction means a degree of freedom and obviously not the directions to and fro on the rails. This is possible, for example, with a vehicle having steerable wheels, which is discussed at greater length below.

In an embodiment, the device is configured to execute one or more of the following operations on or near the teats of the dairy animal:
cleaning and/or disinfecting the teats of a dairy animal;
attaching one or more milking cups to one or more teats of a dairy animal;
reattaching the one or more milking cups to one or more teats of a dairy animal;
detaching the one or more milking cups from one or more teats of a dairy animal; and after-treating the teats of a dairy animal.

In an embodiment, the robot arm has a gripper for gripping a milking cup in order to be able to attach the milking cup to a teat of a dairy animal.

In a further embodiment, the device is configured to execute the operations on a dairy animal which is situated on the rotatable milking floor of the milking device.

In another embodiment, the milking floor is situated at least half a meter.

In an embodiment, the robot arm can move in a single, substantially vertical plane with respect to the undercarriage.

In an embodiment, the vertical plane is substantially perpendicular to a main direction of travel of the device.

In another embodiment, the robot arm is provided with a sensor or camera for determining the position of the teats of a dairy animal.

In an embodiment, the device is configured to move along with the rotatable milking floor in a substantially tangential direction during the execution of one or more operations.

In an embodiment, the device comprises a control device to control movements of the device and/or to control the robot arm, and/or to control other functions of the device.

In a further embodiment of the invention, a milking device is provided which comprises several or a plurality of milking stations which each have one or more milking cups, and wherein the milking device has a rotatable milking floor on which the dairy animals are situated during milking, wherein the milking device furthermore comprises at least one milking pit with a stationary pit floor which is lower than the milking floor to such a degree that the operations on the dairy animal in the milking device which are necessary for milking are executable for an average milker while standing on the pit floor, wherein the milking device further comprises at least one autonomous device.

In an embodiment, the milking device comprises several or a plurality of autonomous devices.

In a further embodiment, the milking device comprises a plurality of autonomous devices, wherein each of the moving autonomous devices is configured to attach one milking cup of a milking station to a teat of a dairy animal which is situated in the milking station.

In an embodiment of the invention, a method of milking a dairy animal is provided comprising providing a milking device which comprises a plurality of milking stations, each of which has one or more milking cups, and wherein the milking device has a rotatable milking floor on which the dairy animals are situated during milking, wherein the milking device furthermore comprises at least one milking pit with a stationary pit floor which is situated at a lower level than the milking floor, the method further comprising:

providing an autonomous device for executing one or more operations on or near the teats of a dairy animal for the purpose of milking the dairy animal, wherein the device comprises a self-propelled wheeled undercarriage which can move on the pit floor, and a robot arm which is fitted to the undercarriage and configured to execute the one or more operations, executing the one or more operations by means of the autonomous device while the self-propelled wheeled undercarriage is supported on the pit floor, and milking the dairy animal.

It should be noted that the characteristic “which pit floor is situated so much lower than the milking floor that an average milker can carry out the operations required for milking on the dairy animal while standing on the pit floor” means that the dimensions of the autonomous device are adapted to those of a human. All this means that the autonomous device will have to be able to reach significantly greater heights than substantially horizontally with the dairy animals on the same floor height as the milker. The latter is irresponsible from a health and safety point of view as the milker has to reach very low depths, but is not an issue with automatic robot milking carousels which are configured as a fully automated system. One of the conceivable advantages of the current device in addition to the fact that the autonomous device and the milker can be used interchangeably is that a single autonomous device can be shared by several milking carousels, so that the purchase costs can also be divided.

It should be noted that devices are known for automatically attaching one or more milking cups in a milking device for dairy animals. However, such devices are not suitable as autonomous connecting devices according to the invention, wherein the connecting device is used for attaching milking cups in an existing milking device, for example, a milking device with a rotating milking carousel. This is inter alia due to the difference in height between the pit floor and the milking floor and the fact that the pit floor and the milking floor move with respect to one another. In practice, the difference in height may be greater than half a meter and may even be more than a meter. These known devices are in addition not able to attach the milking cups while the dairy animal passes by on the milking carousel or another moving milking floor.

In an embodiment, the device is configured to execute one or more of the following operations on or near the teats of a dairy animal:
cleaning and/or disinfecting the teats of a dairy animal;
attaching one or more milking cups to one or more teats of a dairy animal;
reattaching the one or more milking cups to the one or more teats of a dairy animal;
detaching the one or more milking cups from the one or more teats of a dairy animal; and
after-treating the teats of a dairy animal.

Advantageously, the device is configured to attach one or more milking cups to the one or more teats of a dairy animal to be milked. To this end, the robot arm may be provided with a gripper for gripping a milking cup in order to be able to attach the milking cup to the teat of the dairy animal. Any other suitable manner for picking up and attaching a milking cup to a teat can also be used in the robot arm.

In a preferred embodiment, the device is configured to execute the operations on a dairy animal which is situated on the rotatable milking floor of the milking device.

The device can also be used in any other milking device with a milking station whose milking floor, that is to say the floor on which the dairy animal is situated during milking, is higher than the pit floor on which the autonomous device is supported and on which an average milker can execute the operations required for milking in a standing position.

In an embodiment, the self-propelled wheeled undercarriage has a number of wheels which are driven by one or more motors, for example, an electric motor. The undercarriage furthermore preferably comprises an energy store, for example, a battery.

The autonomous device furthermore preferably comprises a number of position sensors to determine the position with respect to the respective milking station and a control device to control the one or more motors for positioning the device. Alternatively, one or more wheels are steerable, in which case the control device controls the steering thereof. The control device or another control device may also be used to control the robot arm and/or to control other functions of the device.

The robot arm may be any suitable robot arm for executing the one or more operations, in particular the attachment of the milking cups. The robot arm may optionally be provided with a sensor or camera for determining the position of the teats of the dairy animal in order to facilitate the execution of the operations.

In an embodiment, the robot arm moves in a single plane which is substantially vertical with respect to the undercarriage. Such a robot arm can be produced and controlled relatively easily. This plane is preferably situated in a direction which is substantially at right angles to a main direction of travel of the device. Movements of the robot arm in a direction at right angles to the plane can then easily be achieved by moving the device.

In an embodiment, the device comprises a communication system to communicate with an actuating device of the milking device. By means of such a communication system, the device can exchange information with the milking device, for example, about the specific teat positions of a certain dairy animal or about whether the attachment of the milking cups to the teats of a certain dairy animal has been successful or not.

In an embodiment, the device is configured to move along with the milking carousel in the tangential direction during the execution of the one or more operations, in particular with the milking station associated therewith at said point in time. If, for example, the time for which a dairy animal rotates on the milking carousel is too short to attach the one or more milking cups to be attached, the device may move along with the milking carousel in a substantially tangential direction, that is to say remaining at approximately the same distance from the periphery of the milking carousel, in order to make it possible to attach the milking cups.

In an embodiment, the device is configured to reattach a milking cup if this has become detached too soon from a teat of a dairy animal. As a result of the large degree of freedom of movement of the device according to the invention, it is also possible to use it for reattaching milking cups which have become detached too soon, for example, as a result of not having been attached correctly or having been kicked off by the dairy animal.

The invention furthermore relates to a milking device which comprises several milking stations which each have one or more milking cups, and wherein the milking device has a rotatable milking floor on which the dairy animals are situated during milking, wherein the milking device furthermore comprises at least one milking pit with a stationary pit floor which is lower than the milking floor to such a degree that an average milker who is standing on the pit floor can carry out the operations on the dairy animal in the milking device which are necessary for milking, wherein the milking device comprises an autonomous device which travels on the pit floor.

In such a milking device, it is possible to provide several moving autonomous devices which can alternate, for example if the battery of one of the devices has to be recharged or if said device is not available for another reason. It is also possible to use the devices for different operations, for example one of the devices for attaching the milking cups and one of the devices for reattaching milking cups if the milking cups become detached too soon during milking of the dairy animals, or for pre-treatment or after-treatment of the teats of a dairy animal.

In an embodiment, the milking device comprises several moving autonomous devices, with each of the moving autonomous devices being configured to attach one milking cup of a milking station to a teat of a dairy animal which is situated in the milking station. It is, for example, possible that the time available for attaching, for example, four milking cups is relatively short if a dairy animal moves past on a milking carousel. As an addition or alternative to the device moving along, it is possible for several devices to be placed next to one another along the periphery of the milking carousel which only attach some, for example, one or two, of the total number of milking cups.

The milking device may, for example, comprise four moving autonomous devices, each of the four autonomous devices being configured to attach a milking cup of a milking station comprising a set of four milking cups to a teat of a dairy animal which is situated in the milking station. It is also possible for each autonomous device to attach two milking cups.

The invention furthermore relates to a method of milking a dairy animal in a milking device which comprises several milking stations, each of which has one or more milking cups, and wherein the milking device has a rotatable milking floor on which the dairy animals are situated during milking, wherein the milking device furthermore comprises at least one milking pit with a stationary pit floor which is situated at a lower level than the milking floor, the method comprising:

providing an autonomous device according to the invention for executing one or more operations on or near the teats of a dairy animal for the purpose of milking the dairy animal, comprising a self-propelled wheeled undercarriage which can travel across a floor surface, preferably in at least two independent directions and freely, and a robot arm which is fitted to the undercarriage and configured to execute the one or more operations on or near the teats of the dairy animal, executing the one or more operations on or near the teats by means of the autonomous device while the latter is supported on the pit floor, and milking the dairy animal.

### BRIEF DESCRIPTION OF THE DRAWINGS

The features and advantages of the invention will be appreciated upon reference to the following drawings, in which:

FIG. 1 shows a top view of an embodiment of a milking device according to the invention; and

FIG. 2 shows a front view of an autonomous connecting device according to the invention next to a milking carousel.

### DESCRIPTION OF ILLUSTRATIVE EMBODIMENTS

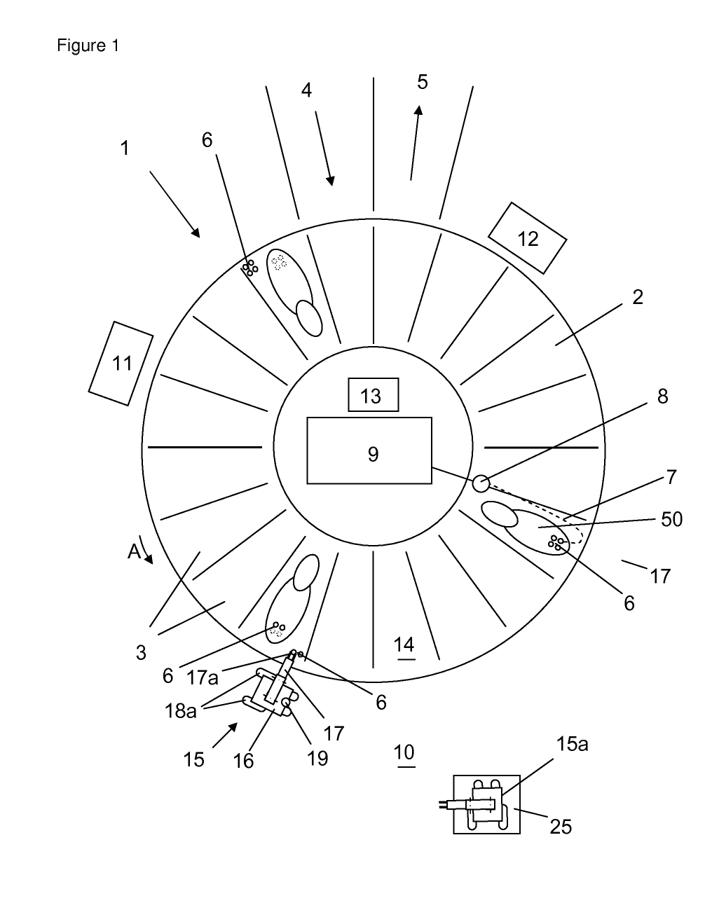

The following is a description of certain embodiments of the invention, given by way of example only and with reference to the drawings. FIG. 1 shows a first embodiment of a milking device 1 according to the invention for milking dairy animals 50. The milking device 1 comprises a rotatable milking carousel 2 with several milking stations 3 which are distributed along the periphery of the milking carousel 2. The milking carousel 2 is a platform which is slowly rotated in the direction indicated by arrow A. Dairy animals 50 can enter a milking station 3 on the milking carousel via an entrance 4 and can leave the milking carousel 2 again via an exit 5. While a milking station 3 rotates from the entrance 4 to the exit 5, a dairy animal 50 which is situated in the milking station 3 can be milked.

It should be noted that only single dairy animals 50 are shown in the diagrammatic figures. In practice, the occupancy rate of a milking carousel will be much greater. In addition, the milking carousel may have a much larger number of milking stations than is illustrated in the figures.

Each milking station 3 is provided with a set of milking cups 6 which can be attached to the teats of a dairy animal 50 which is situated on the milking station 3. The milking cups 6 are connected to a first temporary reservoir 8 by a milk pipe system 7 and subsequently to a consumption milk tank 9 which is intended to collect milk for consumption.

Furthermore, a pre-treatment device 11 is provided for cleaning and/or massaging the teats of the dairy animals before milking and an after-treatment device 12 for the after-treatment of the teats of the dairy animals after milking.

While a dairy animal 50 situated in a milking station 3 on the milking carousel 2 rotates, the various stages of the milking process are being carried out in succession. In a first stage, the dairy animal is prepared to be milked. The teats of a dairy animal 50 can be cleaned and/or massaged by means of the pre-treatment device 11. After this preparatory stage, milking of the dairy animal 50 can be started, in which case the milking cups 6 are attached to the teats of the dairy animal first. During milking, the milk is temporarily stored in the temporary milk tank 8 via the milk pipe system 7 (pipe is only shown for one milking cup). Subsequently, the milk is discharged further to the consumption milk tank 9. It is also possible, if desired, to discharge the milk directly to the consumption milk tank 9.

After the dairy animal 50 has been milked, the milking cups 6 can be detached from the teats again, for example by releasing the vacuum in the milk pipe system 7 which is used for milking, and then pulling off the milking cups 6. After the milking cups 6 have been detached and an optional after-treatment with the after-treatment device 12 has taken place, the dairy animal 50 can leave the milking carousel 2 via the exit 5. Then, the same milking station 3 can be entered by a new dairy animal 50 via the entrance 4.

In a conventional milking device, the milking cups 6 are attached manually. In order to make it possible for individuals to carry out this attachment procedure in an upright position, a milking pit with a pit floor 10 is provided, which pit floor 10 is at a substantially lower level than the carousel floor 14, that is to say the (milking) floor of the milking carousel 2 on which the dairy animals 50 are situated during milking. The pit floor 10 is usually situated at a level which is more than 50 centimeters, preferably more than one meter lower than the carousel floor 14.

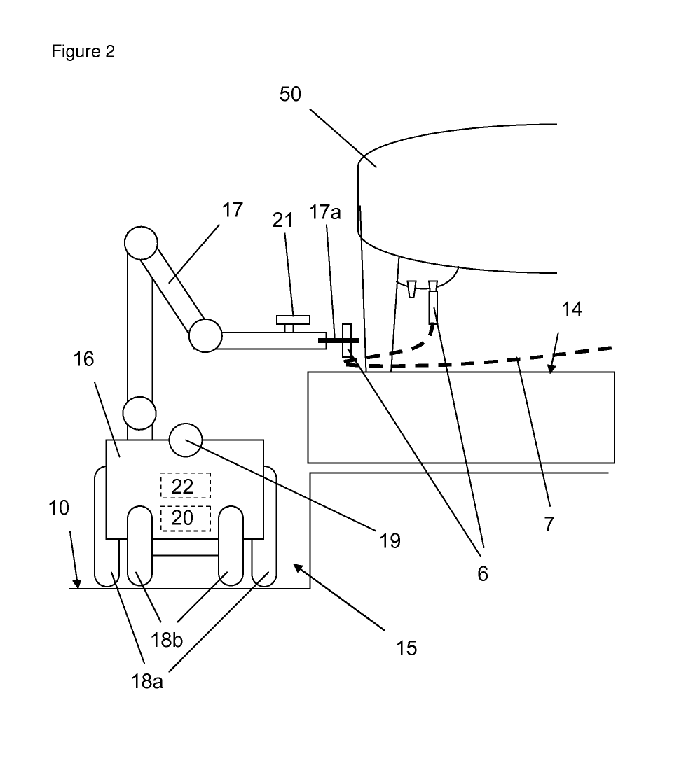

In the milking device 1 from FIG. 1, an autonomous connecting device 15 for attaching the milking cups 6 is provided which can carry out the manual operation of attaching the milking cups required in the conventional milking device. FIG. 2 shows a front view of the connecting device 15.

The connecting device 15 travels across the pit floor 10 and is configured to attach milking cups 6 to teats of dairy animals which are situated on the carousel floor 14.

The connecting device 15 comprises a self-propelled wheeled undercarriage 16 and a robot arm 17 fitted to the undercarriage and configured to attach the one or more milking cups 6 to the teats of a dairy animal 50 which is situated on or in the milking station 3.

The self-propelled wheeled undercarriage 16 has a number of wheels 18a which are driven by electric motors. The undercarriage 16 comprises a battery which provides the power for the electric motors in order to drive the wheels 18a and which also provides the power for the robot arm 17. It is also possible to use any other suitable manner of driving the undercarriage 16 and the robot arm 17. By means of the wheels 18b, the undercarriage 16 can be steered in different directions.

The connecting device 15 furthermore preferably comprises a number of position sensors 19 to determine the position with respect to the milking carousel 2, and a control device 20 to control the various functions of the connecting device 15.

The robot arm 17 may be any robot arm 17 which is suitable for attaching the milking cups 6. The robot arm 17 comprises a gripper 17a for gripping a milking cup 6 in order to attach it to a teat of a dairy animal 50. Optionally, the robot arm 17 may be provided with a sensor or camera 21 to determine the position of the teats of the dairy animal 50 and thus facilitate attachment.

The robot arm 17 can only be moved in a substantially vertical plane with respect to the undercarriage 16. This plane is substantially at right angles to the main direction of travel.

The connecting device 15 comprises a communication system 22 to communicate with an actuating device 13 of the milking device 1. By means of such a communication system, the device can exchange information with the milking device, for example about the specific teat positions of a certain dairy animal or about whether the attachment of the milking cups to the teats of a certain dairy animal has been successful or not.

The connecting device 15 is configured to, if necessary, travel along with the milking carousel 2 in the tangential direction during attachment of the milking cups 6 in case there is not sufficient time to attach the milking cups from a stationary position.

It should be noted that the connecting device 15 may also be configured to execute other operations on or near the teats of a dairy animal for the purpose of milking the dairy animal. These operations may comprise, for example, cleaning and/or disinfecting the teats of a dairy animal, detaching the one or more milking cups from one or more teats of a dairy animal and/or after-treating the teats of a dairy animal. The device may then, for example, be configured to operate the pretreatment device 11 or the after-treatment device 12.

It is also possible to provide separate autonomous devices for this purpose.

FIG. 1 shows a second connecting device 15a which is identical to the first connecting device 15. The second connecting device 15a is situated on a recharging station 25 for recharging the battery of the connecting device 15a.

It is advantageous to provide several connecting devices, such as a second connecting device 15a. When several connecting devices are provided, a connecting device is available if the first one is temporarily unavailable, for example, when the battery is being recharged. In addition, two connecting devices 15, 15a offer the possibility of distributing the work of attaching the milking cups 6 of a milking station 3, as a result of which more time is available per connecting device 15, 15a for executing said task. It is, for example, also possible to provide four connecting devices which each attach one milking cup 6 per milking station. The four connecting devices can then be arranged next to one another along the periphery of the milking carousel 2 and each can successively attach one of the milking cups 6.

Furthermore, a second connecting device 15a can be used to reattach a milking cup 6 if it becomes detached too soon from a teat of a dairy animal. Due to the large degree of freedom of movement of the connecting devices 15, 15a, one of the connecting devices 15, 15a can be used to reattach a milking cup if it becomes detached before the end of milking, for example, due to the milking cup not having been attached correctly or having been kicked off by the dairy animal.

The device according to the invention is described above as a device which can be used to automate the attachment of milking cups in an existing milking device and/or other operations on or near the teats of the dairy animal. Obviously, it is also possible to provide the device as a component of a new milking device.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. An autonomous device for executing one or more operations on or near teats of a dairy animal for the purpose of milking the dairy animal, comprising:
a self-propelled wheeled undercarriage which can travel across a floor surface, and
a robot arm fitted to the undercarriage and configured to execute the one or more operations on or near the teats of the dairy animal,
wherein the device is configured to execute the one or more operations in a milking device with a rotatable milking floor on which the dairy animals are situated during milking, and
wherein the device is supported on a stationary pit floor during the execution of the one or more operations, which pit floor is situated at least 50 centimeters lower than the milking floor such that an average milker can carry out the operations required for milking on the dairy animal while standing on the pit floor.

2. The device according to claim 1, wherein the device is configured to execute one or more of the following operations on or near the teats of the dairy animal:
cleaning and/or disinfecting the teats of a dairy animal;
attaching one or more milking cups to one or more teats of a dairy animal;
reattaching the one or more milking cups to one or more teats of a dairy animal;
detaching the one or more milking cups from one or more teats of a dairy animal; and
after-treating the teats of a dairy animal.

3. The device according to claim 1, wherein the robot arm has a gripper for gripping a milking cup in order to be able to attach the milking cup to a teat of a dairy animal.

4. The device according to claim 1, wherein the device is configured to execute the operations on a dairy animal which is situated on the rotatable milking floor of the milking device.

5. The device according to claim 1, wherein the milking floor is situated at least half a meter.

6. The device according to claim 1, wherein the robot arm can move in a single, substantially vertical plane with respect to the undercarriage.

7. The device according to claim 3, wherein the vertical plane is substantially perpendicular to a main direction of travel of the device.

8. The device according to claim 1, wherein the robot arm is provided with a sensor or camera for determining the position of the teats of a dairy animal.

9. The device according to claim 1, wherein the device is configured to move along with the rotatable milking floor in a substantially tangential direction during the execution of the one or more operations.

10. The device according to claim 1, wherein the device comprises a control device to control movements of the device and/or to control the robot arm, and/or to control other functions of the device.

11. A milking device which comprises several milking stations which each have one or more milking cups, and wherein the milking device has a rotatable milking floor on which the dairy animals are situated during milking, wherein the milking device furthermore comprises at least one milking pit with a stationary pit floor which is lower than the milking floor by at least 50 centimeters such that the operations on the dairy animal in the milking device which are necessary for milking are executable for an average milker while standing on the pit floor, wherein the milking device further comprises at least one autonomous device according to claim 1.

12. The milking device according to claim 11, wherein the milking device comprises a plurality of autonomous devices according to claim 1.

13. The milking device according to claim 12, wherein each one of the plurality of moving autonomous devices is configured to attach one milking cup of a milking station to a teat of a dairy animal which is situated in the milking station.

14. A method of milking a dairy animal comprising
providing a milking device which comprises a plurality of milking stations, each of which has one or more milking cups, and
wherein the milking device has a rotatable milking floor on which the dairy animals are situated during milking,
wherein the milking device furthermore comprises at least one milking pit with a stationary pit floor which is situated at a lower level than the milking floor, the method further comprising:
providing an autonomous device for executing one or more operations on or near the teats of a dairy animal for the purpose of milking the dairy animal,
wherein the autonomous device comprises a self-propelled wheeled undercarriage which can move on the pit floor, and a robot arm which is fitted to the undercarriage and configured to execute the one or more operations,
wherein the autonomous device executes the one or more operations while the self-propelled wheeled undercarriage is supported on the pit floor, and
milking the dairy animal.
